(19) United States
(12) Patent Application Publication
(10) Pub. No.: US 2014/0139402 A1
(43) Pub. Date: May 22, 2014

(54) METHOD FOR PRODUCING LOGICAL AREA-BASED HANGING PROTOCOLS FOR MULTIPLE MONITOR WORKSTATIONS

(71) Applicant: GENERAL ELECTRIC COMPANY, Schenectady, NY (US)

(72) Inventors: Dmitry Pavlov, Park Ridge, NJ (US); Christopher Olivier, Saddle Brook, NJ (US); Maurizio Menni, Park Ridge, NJ (US)

(73) Assignee: GENERAL ELECTRIC COMPANY, Schenectady, NY (US)

(21) Appl. No.: 13/682,481

(22) Filed: Nov. 20, 2012

(51) Int. Cl. G09G 5/00

(52) U.S. Cl. CPC G09G 5/00
USPC 345/1.1

(57) ABSTRACT

Embodiments of the present invention provide a method for producing a logical area-based hanging protocol for multiple monitor workstations. The method includes matching one or more monitors to one or more logical areas corresponding to the display characteristics of said monitors, specifying one or more visual components to be displayed in said logical areas, mapping said visual components to said logical areas, and displaying said visual components on the one or more monitors.

### RELATED APPLICATIONS

Not applicable.

### BACKGROUND OF THE INVENTION

This subject matter generally relates to an improvement in hanging protocol configuration in a picture archiving and communication system. In particular, the present invention relates to multiple-monitor configurations of hanging protocols in a picture archiving and configuration system.

Picture archiving and communication systems (“PACS”) connect to medical diagnostic imaging devices and employ an acquisition gateway (between the acquisition device and the PACS), storage and archiving units, display workstations, databases, and sophisticated data processors. These components are integrated together by a communication network and data management stream. A PACS has, in general, the overall goals of streamlining health-care operations, facilitating distributed remote examination and diagnosis, and improving patient care.

A typical application of a PACS system is to provide one or more medical images for examination by a medical professional. For example, a PACS system can provide a series of x-ray images to a display workstation where the images are displayed for a radiologist to perform a diagnostic examination. Based on the presentation of these images, the radiologist can provide a diagnosis. For example, the radiologist can diagnose a tumor or lesion in x-ray images of a patient's lungs.

The images in an imaging study typically are displayed in a particular spatial layout and/or temporal sequence. In other words, the images may be displayed in certain positions on a display device relative to each other (a spatial layout, for example). The images may also be displayed in a certain ordered sequence by displaying image A first, followed by image B, followed by image C, and so on (a temporal sequence, for example). The spatial and/or temporal presentation of images is directed by a set of display rules. A display rule may include a set of instructions stored on a computer-readable media that direct the presentation of images on a display workstation. A set of display rules is known as a hanging protocol. In general, a hanging protocol is a series of display rules that dictate the spatial and/or temporal layout and presentation of a plurality of images.

A hanging protocol for a radiology workstation can rely on multiple factors to determine the layout of the images in an imaging study. For example, the imaging modality used to obtain images in the study, such as CT scan or MRI, can play a critical role. For each modality, the images produced are distinct, and require displaying and grouping in different ways. An x-ray may produce a small number of images for a single group, while a CT scan can produce hundreds or thousands of images combined in different groups. The hanging protocol determines how the screen is divided, and how the different images are positioned on the screen for different modalities.

It is common in modern hospitals for medical professionals and other IT system users to employ many different display workstations for their tasks. Their setups may use multiple monitor configurations throughout multiple rooms and environments. For example, one office may have two monitors, another may have five monitors, while at home a medical professional may use a single monitor. The devices and monitors used may have drastically varying sizes and display characteristics. These characteristics include the number of megapixels, whether the screen is in color or black and white, what orientation the image is in, and whether the equipment is medical grade or non-medical grade. In this context, the creation of consistent hanging protocols often leads to complications.

Currently, the challenge of multiple monitor configurations has been addressed by creating separate hanging protocols for different monitor configurations. However, it is difficult and impractical for medical professionals and IT system users to manage a large amount of hanging protocols. Further, using a single hanging protocol for multiple configurations leads to situations where some images are too small for certain monitors, while others are too zoomed in.

Thus, a need exists for a system capable of reducing the number of required hanging protocols, while encompassing and meeting the varied imaging specifications of multiple monitor configurations. Further, a need exists for increased flexibility and user configuration of hanging protocols.

### SUMMARY OF THE INVENTION

Embodiments of the present invention provide a method for producing a logical area-based hanging protocol for multiple monitor workstations. The method includes matching one or more monitors to one or more logical areas corresponding to the display characteristics of said monitors, specifying one or more visual components to be displayed in said logical areas, mapping said visual components to said logical areas, and displaying said visual components on the one or more monitors.

Embodiments of the presently described technology also provide a non-transitory computer-readable storage medium comprising a set of instructions for a computer. The set of instructions include a definition routine, a selection routine, a mapping routine and a display routine. The definition routine is configured to define one or more logical areas of a hanging protocol according to one or more display characteristics. The matching routine is configured to match one or more monitors to said logical areas according to said display characteristics. The selection routine is configured to specify one or more visual components to be displayed on said monitors. The mapping routine is configured to determine whether said visual components can be displayed on said monitors without overlapping and to map said visual components to said monitors. The display routine is configured to display said visual components on the one or more monitors.

Embodiments of the present invention also provide a method for producing a logical area-based hanging protocol for multiple monitor workstations. The method includes mapping one or more visual components to one or more monitors in a medical imaging system based on the display characteristics of said monitors.

Systems, methods, and computer program products of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 illustrates an exemplary PACS system in accordance with an embodiment of the present technology.

FIG. 2 illustrates a flowchart for a method for providing a logical area-based hanging protocol for multiple monitor workstations, in accordance with an embodiment of the presently-described technology.

FIG. 3 illustrates a schematic diagram of an example embodiment of the presently described technology.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

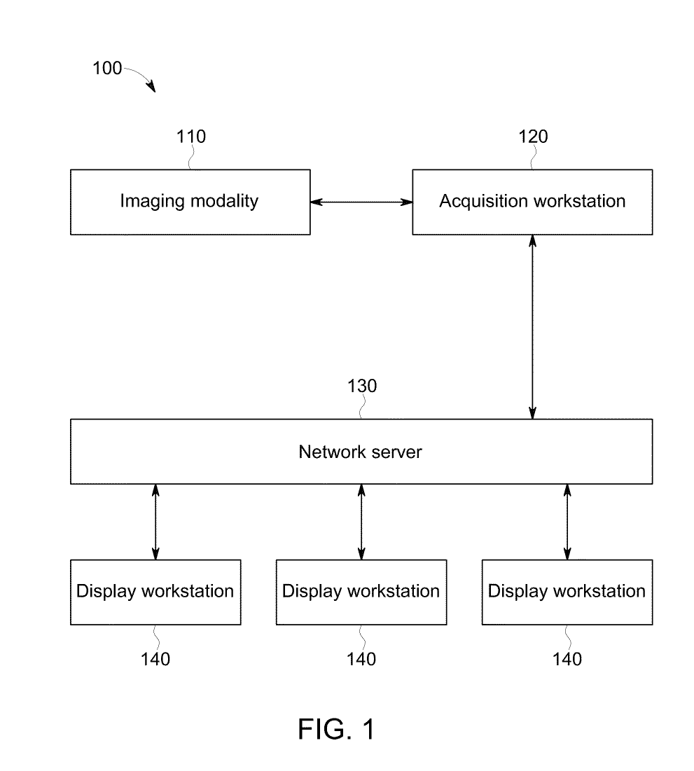

FIG. 1 illustrates an exemplary PACS system 100 in accordance with an embodiment of the present invention. PACS system 100 includes an imaging modality 110, an acquisition workstation 120, a network server 130, and one or more display workstations 140. System 100 can include any number of imaging modalities 100, acquisition workstations 120, network servers 130 and display workstations 140 and is not in any way limited to the embodiment of system 100 as illustrated in FIG. 1.

In operation, imaging modality 110 obtains one or more images of a patient anatomy. For example, imaging modality 110 can obtain a a one, two, three or other dimensional image of a patient anatomy. Alternatively, imaging modality 110 can obtain a plurality of images or image data that is later converted into a three or more dimensional image of a patient anatomy. Imaging modality 110 can include any device capable of capturing an image of a patient anatomy such as a medical diagnostic imaging device. For example, imaging modality 110 can include an X-ray imager, ultrasound scanner, magnetic resonance imager, or the like. Image data representative of the image(s) is communicated between imaging modality 110 and acquisition workstation 120. The image data can be communicated electronically over a wired or wireless connection.

Acquisition workstation 120 can apply one or more preprocessing functions to the image data in order to prepare the image for viewing on a display workstation 140. For example, acquisition workstation 120 may convert raw image data into a DICOM standard format or attach a DICOM header. The preprocessing functions can be characterized in that they can be modality specific enhancements (for example, contrast or frequency compensation functions specific to a particular X-ray imaging device, for example) applied at the beginning of the imaging and display chain.

The image data may then be communicated between acquisition workstation 120 and network server 130. The image data can be communicated electronically over a wired or wireless connection.

Network server 130 can include a computer-readable storage medium suitable for storing the image data for later retrieval and viewing at a display workstation 140. Network server 130 can also include one or more software applications for additional processing and/or preprocessing of the image data by one or more display workstations 140, as described below.

One or more display workstations 140 are capable of or configured to communicate with server 130. Display workstations 140 can include a general purpose processing circuit, a network server 130 interface, a software memory, and an image display monitor. The network server 130 interface may be implemented as a network card connecting to a TCP/IP based network, but may also be implemented as a parallel port interface, for example.

Display workstations 140 may retrieve or receive image data from server 130 for display to one or more users. For example, a display workstation 140 may retrieve or receive image data representative of a computed radiography (“CR”) image of a patient's chest. A radiologist may then examine the image as displayed on a display device for any objects of interest such as, for example, tumors, lesions, etc.

Display workstations 140 are also capable of or configured to retrieve and/or receive one or more hanging protocols from server 130. For example, a default hanging protocol may be communicated to display workstation 140 from server 130. A hanging protocol may be communicated between server 130 and a display workstation 140 over a wired or wireless connection, for example.

In general, display workstations 140 may present images representative of image data retrieved and/or received from server 130. Display workstations 140 may present the images according to a hanging protocol. For example, a hanging protocol can include a set of computer-readable instructions (or display rules, for example) that direct a computer to display a plurality of images in certain locations on a display device and/or display the plurality of images in a certain sequence or order. In another example, a hanging protocol can include a set of computer-readable instructions that direct a computer to place a plurality of images in multiple screens and/or viewports on a display device. In general, a hanging protocol can be employed to present a plurality of images for a diagnostic examination of a patient anatomy featured in the images.

A hanging protocol may direct, for example, a display workstation 140 to display an anterior-posterior (“AP”) image adjacent to a lateral image of the same anatomy. In another example, a hanging protocol may direct display workstation 140 to display the AP image before displaying the lateral image. In general, a hanging protocol can dictate the spatial and/or temporal presentation of a plurality of images at display workstation 140.

A hanging protocol differs from a default display protocol (“DDP”). In general, a DDP is a default workflow that applies a series of image processing functions to image data. The image processing functions are applied to the image data in order to present an image (based on the image data) to a user. The image processing functions alter the appearance of image data. For example, an image processing function may alter the contrast level of an image.

DDPs typically include processing steps or functions that are applied before any diagnostic examination of the images. For example, processing functions may be applied to image data in order to enhance features within an image (based on the image data). Such processing functions can include any software-based application that may alter a visual appearance or representation of image data. For example, a processing function can include any one or more of flipping an image, zooming in an image, panning across an image, altering a window and/or level setting in a representation of the image data, and altering a contrast and/or brightness setting in a representation of the image data.

DDPs are usually based on a type of imaging modality used to obtain the image data. For example, image data obtained with a C-arm imaging device in general or a particular C-arm imaging device may have a same or similar DDP applied to the image data. In general, a DDP attempts to present image data in a manner most useful to many users.

Conversely, applying a hanging protocol to image data does not alter the appearance of an image (based on the image data), but instead dictates how the image(s) is(are) presented, as described above.

Server 130 can store a plurality of hanging protocols. The hanging protocols that are stored at server 130 and have not yet been modified or customized are default hanging protocols. A default hanging protocol can be selected from a plurality of default hanging protocols based on any number of relevant factors such as, for example, a manual selection of the default hanging protocol, a user identity, and/or pre-processing of the image data.’

Specifically, a default hanging protocol may be selected based on a manual selection simply by communicating the default hanging protocol once a user has selected that particular protocol. The user can make the selection, for example, at a display workstation 140.

Server 130 includes a computer-readable storage medium. The storage medium can include a computer hard drive, a compact disc (“CD”) drive, a USB thumb drive, or any other type of memory capable of storing one or more computer software applications. The storage medium includes a set of instructions for a computer. The set of instructions includes one or more routines capable of being run or performed by workstations 140. The set of instructions can be embodied in one or more software applications or in computer code. As described in more detail below, one technical effect of the set of instructions is to recommend, provide and/or adapt one or more hanging protocols or changes to hanging protocols to increase the efficiency of a user in reading an imaging study.

In or more embodiments, a hanging protocol is determined and selected based on a plurality of logical areas. Logical areas are areas in monitor displays that possess particular shared display characteristics. Logical areas allow monitors to be matched with visual components that are suited for their particular displays. For example, it may be the case that mammography x-rays can only be optimally displayed on a monitor with a certain minimum number of megapixels, such as five megapixels. Meanwhile, for general reading a three-megapixel monitor may be suitable. In such a situation, one logical area can be defined as monitors possessing five megapixels that mammography x-ray components can be displayed on, while another logical area can be defined as monitors possessing three megapixels that general reading components can be displayed on. Once these logical-area based groupings are defined, it becomes possible to identify the shared characteristics on the monitors in display workstations 140. The method can match the logical area definitions in a hanging protocol to the logical areas on the physical workstations 140 where the hanging protocol is applied.

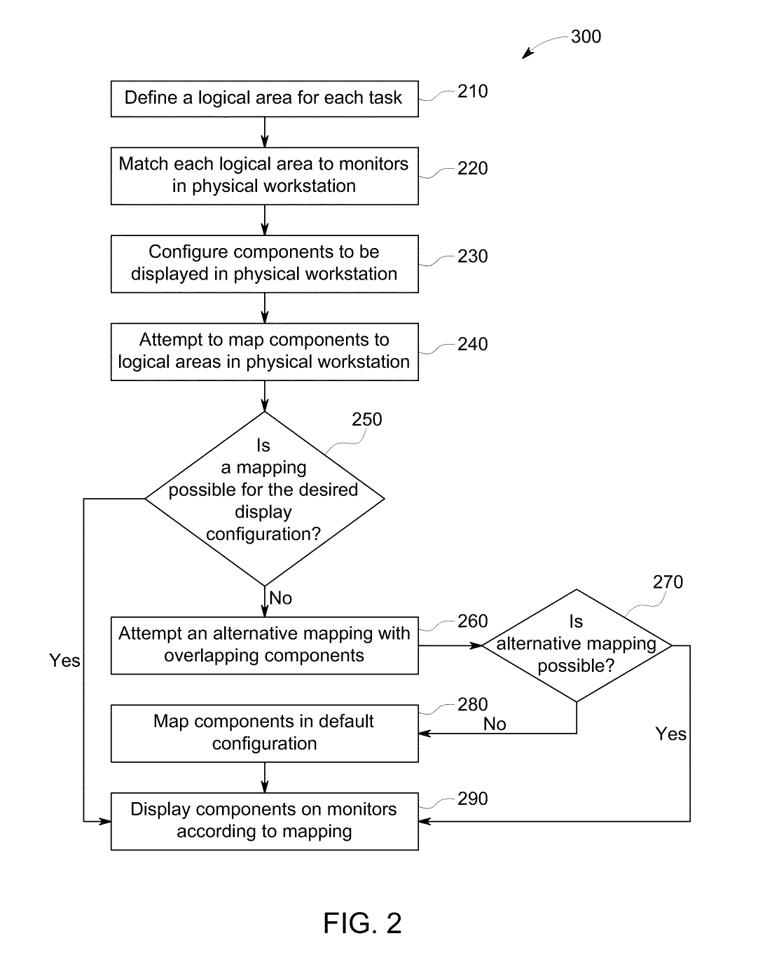

FIG. 2 illustrates a flowchart for a method for providing a logical area-based hanging protocol for multiple monitor workstations, in accordance with an embodiment of the presently-described technology. First, at step 210, a logical area is defined for a task. This involves determining what characteristics of monitors are suitable for displaying specific visual components. One particular example of a set of logical areas may specify that landscape monitors are suited for text, three-megapixel monitors are suited for general reading, and five-megapixel monitors are suited for mammography x-rays. Logical area definitions need not be determined each time a hanging protocol is needed for a set of displays. In one embodiment, users may create and configure logical area definitions. In another embodiment, users can select from a variety of logical area definitions. Logical area definitions can be saved and loaded on the system for a plurality of modalities and environments, and recorded in a database for storage and recall as needed. Each hanging protocol must have one or more definitions of logical areas for each task or visual component.

In step 220, the logical area definitions are matched to particular displays on the physical workstations that share the same or identical characteristics. For each physical workstation display, the method determines whether it matches the characteristics of each logical area definition specified in the hanging protocol. For example, if the workstation displays consist of a landscape monitor, a two-megapixel monitor and a five-megapixel monitor, then the landscape monitor will fit the characteristics of the logical area definition for displaying text, while the five-megapixel monitor will fit the characteristics of the logical area definition for displaying mammography images. As a result of this matching, the present method identifies which logical areas exist on the physical set of monitors present.

In step 230, visual components are selected and configured by a user to be displayed on the physical display workstations. The visual components are the visual elements that make up the slides to be displayed within the present logical areas. One visual component may be a CT scan image, another may be text consisting of a patient's history, while another may be a radiologist's notes and reports. Other visual components may include worklists, three-dimensional images, applications for processing images and more. A user has the ability to select from the available visual components that should be displayed, and load visual components from various parts of the PACS workspace.

Step 240 begins the process of attempting to map desired visual components to present logical areas on display workstations. In step 240, a mapping of the desired display to the available set of monitors is attempted. The system determines whether desired display configuration can be mapped to the appropriate logical areas of the displays without any visual components overlapping. For example, if the visual components needed are text and an image, and the display configuration of the monitors allows for both of these components to be displayed without either overlapping visually on the displays or being suboptimally displayed on monitors not suited for displaying them, then the desired display mapping can be achieved. Step 250 involves the method automatically determining whether the desired mapping of step 240 is possible. If it is, then the system maps the visual components to the present logical areas, and the mapping process can end. If the desired display is not possible, then an alternative mapping will be attempted.

In step 260, an alternate mapping is attempted when a desired mapping is not possible. The method of the present technology makes decisions about which visual components can overlap in order for the user's view to be least obstructed. The decision on which visual components will be covered by other visual components can be automated or can be determined by the user. In an embodiment, the user is prompted with a dialogue to select which visual components will overlap in which of the present logical areas. In another embodiment, an automated system has a ruleset which is consulted to determine which visual components are allowed to overlap. For example, if it the system uses a rule that allows for a patient record to be covered by an x-ray, then that will be an acceptable mapping for that logical area. In step 270, if an alternative mapping is possible in which visual components overlap in an acceptable way, then the system maps the visual components to the present logical areas accordingly, and the mapping process can end. If an alternative mapping for the components is not possible, then the components will be mapped according to a default configuration.

In step 270, after a desired mapping and an alternative mapping have been attempted and have been determined to not be possible, the visual components are mapped to the logical areas in a default configuration. A default configuration is constructed in such a way that the visual components needed will always match to existent logical areas, regardless of overlapping of visual components. For example, part of the text of a patient's history may be covered by an x-ray image, regardless of whether this is a non-obstructive view.

In step 280, the visual components are distributed to the present logical areas according to the chosen mapping in steps 240-280, and the components are displayed in their respective logical areas within the monitors of the display workstations.

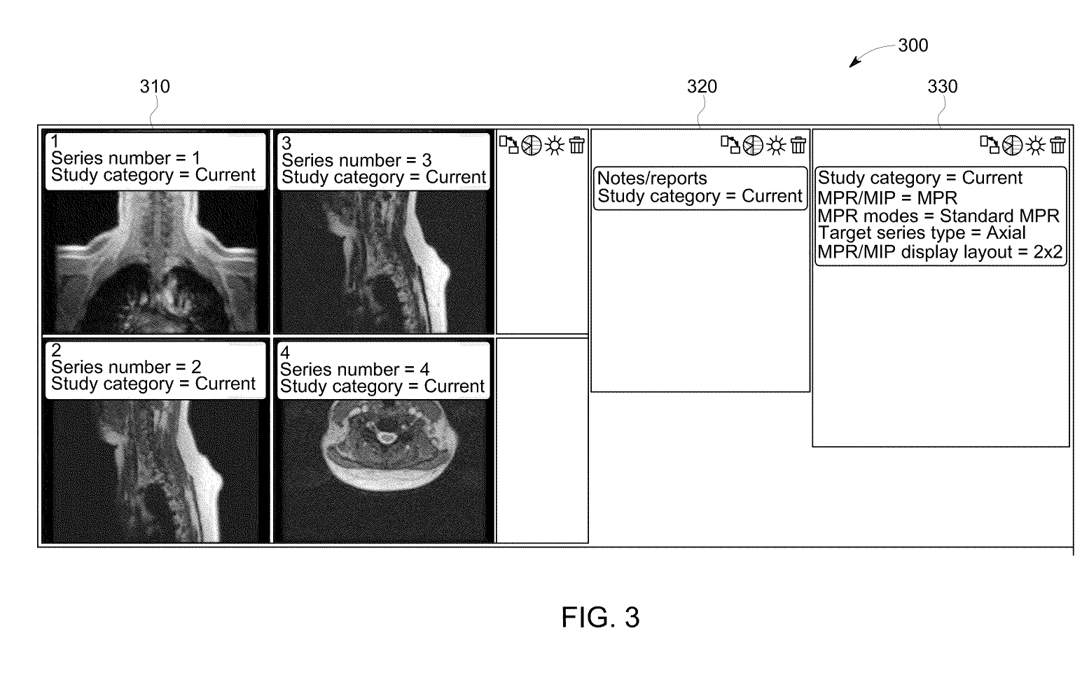

FIG. 3 illustrates a schematic diagram of an example embodiment of the presently described technology. This example depicts a typical hanging protocol configuration interface within a three-monitor setup of display workstations. The three monitors shown on the interface represent the physical monitors present in the environment. Monitors 310, 320 and 330 are all of varying sizes and display characteristics. Monitor 310 is a large, high-megapixel monitor suitable for displaying x-ray images. Monitor 320 is a smaller landscape monitor suitable for text. Monitor 330 is a monitor suitable for MPR and MIP imaging. The characteristics of these monitors have already been associated with logical area definitions, and can be mapped to visual components that are suited for their displays.

During the process of configuring desired visual components to be displayed in a desired configuration (as in step 230), a user will have the option to click on one of the monitors and select a desired visual component for a logical area within the monitor. For example, monitor 310 has been chosen by the user to display four visual components, each an x-ray image. Two empty logical areas remain on monitor 310 for additional components. In addition, the user may select notes and reports to be mapped to monitor 320, and MPR or MIP images to be mapped to monitor 330. The system will map the desired display configuration to the logical areas accordingly. When the same hanging protocol is used for a different display configuration, the system will automatically attempt to map the visual components selected to a desired mapping (steps 240 and 250), and if a desired mapping is not possible, to an alternative mapping (step 260 and 270). If an alternative mapping is not possible, then a default configuration will be selected (step 280). In this example, if a radiologist wished to move this three-monitor display configuration to a setup with a mobile device and one monitor, then the system may automatically determine that the best setup is for notes and reports to be displayed on the mobile device while the x-ray images and other information can be displayed on the monitor. Alternatively, a user can configure the components for the mobile device and monitor as desired.

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features that come within the spirit and scope of the invention.

What is claimed is:

1. A method for producing a logical area-based hanging protocol for multiple monitor workstations, said method including:
matching one or more monitors to one or more logical areas corresponding to the display characteristics of said monitors;
specifying one or more visual components to be displayed in said logical areas;
mapping said visual components to said logical areas; and
displaying said visual components on the one or more monitors.

2. The method of claim 1, wherein said visual components include information and images relating to a medical image study.

3. The method of claim 1, wherein said mapping includes matching said one or more components to a desired display configuration with no visual components overlapping on said one or more monitors.

4. The method of claim 1, wherein said mapping includes matching said one or more components to a display configuration with visual components minimally overlapping on said one or more monitors.

5. The method of claim 1, wherein said mapping includes matching said one or more components to a display configuration with visual components overlapping according to a set of rules for displaying visual components.

6. The method of claim 1, wherein said visual components include image components.

7. The method of claim 1, wherein said visual components include text components.

8. The method of claim 1, wherein said visual components include image viewing applications.

9. The method of claim 1, wherein said display characteristics include at least one of:
(a) number of megapixels;
(b) color functionality of display;
(c) screen orientation of display; and
(d) medical grade quality of display.

10. A non-transitory computer-readable storage medium comprising a set of instructions for a computer, said set of instructions including:
A definition routine configured to define one or more logical areas of a hanging protocol according to one or more display characteristics;
A matching routine configured to match one or more monitors to said logical areas according to said display characteristics;
A selection routine configured to specify one or more visual components to be displayed on said monitors;
A mapping routine configured to determine whether said visual components can be displayed on said monitors without overlapping and to map said visual components to said monitors; and
A display routine configured to display said visual components on the one or more monitors.

11. The method of claim 10, wherein said visual components include information and images relating to a medical imaging study;

12. The method of claim 10, wherein said mapping routine includes mapping said one or more components to a desired display configuration with no visual components overlapping on said one or more monitors.

13. The method of claim 10, wherein said mapping routine includes determining whether said visual components can be displayed on said monitors with minimal overlapping;

14. The method of claim 10, wherein said mapping routine includes matching said one or more components to a display configuration with visual components overlapping according to a set of rules for displaying visual components.

15. The method of claim 10, wherein said mapping routine includes matching said one or more components to a display configuration with visual components overlapping according to a set of rules for displaying visual components.

16. The method of claim 10, wherein said visual components include image components.

17. The method of claim 10, wherein said visual components include text components.

18. The method of claim 10, wherein said visual components include imaging viewing applications.

19. The method of claim 1, wherein said display characteristics include at least one of:
(a) number of megapixels;
(b) color functionality of display;
(c) screen orientation of display;
(d) medical grade quality of display.

20. A method for producing a logical area-based hanging protocol for multiple monitor workstations, said method including mapping one or more visual components to one or more monitors in a medical imaging system based on the display characteristics of said monitors.
